(19) United States
(12) Patent Application Publication
(10) Pub. No.: US 2015/0332400 A1
(43) Pub. Date: Nov. 19, 2015

(54) Method and system for creating a portfolio of equity securities for an investment portfolio

(71) Applicant: Geoffrey William Cutler, Medford, OR (US)

(72) Inventor: Geoffrey William Cutler, Medford, OR (US)

(21) Appl. No.: 14/187,744

(22) Filed: Feb. 24, 2014

(51) Int. Cl. G06Q 40/06; G06F 17/30; G06Q 40/04; G06F 17/24

(52) U.S. Cl. CPC G06Q 40/06; G06F 17/246; G06F 17/30312; G06Q 40/04

(57) ABSTRACT

A computer implemented method and system for selecting stock equities for inclusion in a strategic investment portfolio. The system creates a universe of companies that meet all pre-set conditions based upon Market Capitalization, Senior Unsecured Credit Rating, Outstanding Short and Long term Debt, Shareholders Equity and Dividend History. The companies in this universe are sorted by the net debt as a ratio of shareholders' equity, lowest to highest. The lowest 100 are chosen for “The Cascade Approved 100”. From this list five distinct portfolio strategies are derived: The Lowest Leverage Portfolio, The Total Return Portfolio, The Revenue Growth Portfolio, The Dividend Growth Portfolio and the Low Variability Portfolio.

### BACKGROUND OF THE INVENTION

1. Field of the Invention

The invention relates to computer implemented systems (U.S.CL. 705/35; 705/36R; 705/37) that analyze financial data and create groupings of securities that fall into broadly and narrowly defined categories, and through the process of discrete filtration cause selected issues to be chosen for inclusion into an investment portfolio.

2. Background and Conventional Art

For some time, Exchange-Traded Funds (ETF's) have been offered to the public featuring actively managed strategies aimed at capturing “Alpha” or enhanced returns compared to a baseline index or a narrowly defined industry group. The attempts to gain Alpha have predominately used techniques centered upon “growth” or “value” characteristics, earnings per share growth rates, book value, and recently dividends. There is a need in the art to provide investment strategies that have a focus on the debt and leverage metrics of corporations to facilitate the construction of investment portfolios with high debt quality and low debt leverage as their central attribution.

### BRIEF SUMMARY OF THE INVENTION

The present invention provides computer-implemented methods for selecting securities for an actively managed portfolio, including that of an Exchange-Traded Fund (ETF).

Information on equity securities and certain American Depository Receipts (ADR's) traded on North American Exchanges are electronically collected into a proprietary database maintained by Cascade Investment Counsel. That information includes Market Capitalization, Earnings, Dividends and a wide array of data provided by subscription. In addition certain data is entered manually into the data base which includes Senior Unsecured Debt ratings, Commercial Paper ratings etc. Electronic data is updated monthly, manual data on a real-time basis.

Candidate securities are collected from several sources including the Cascade Approved List, the Standard & Poor's 500, the Russell 3000 and the MSCI All World x US Index (the candidates), and are first screened by Senior Unsecured Debt ratings. Those with less than “Legal Grade” (BBB/Baa) are discarded. Candidates are then screened by Market Capitalization. Those with less than currently desirable capitalization (as this has changed over time) are discarded. Next, candidates are screened for dividend policy. Candidates with no dividend or recent reductions are discarded.

The first embodiment of the invention sorts the Cascade Candidates List first by Senior Unsecured debt ratings removing any without a “A” or higher rating and then by the computer derived Net Debt/Shareholder Equity ratio, lowest to highest. The lowest 100 securities are chosen and are called “The Cascade Approved 100”. From that base of companies, five portfolios are developed. It is envisioned that Exchange Traded Funds be developed to be offered to the public in the strategies outlined in FIGS. 6-10.

### BRIEF DESCRIPTION OF THE DRAWINGS

FIG. 1 is a block diagram of a structure embodiment according to the present invention.

FIG. 2 is a schematic describing the elements necessary to process the invention.

FIG. 3 a schematic to implement Step 100 of the invention.

FIG. 4A is a schematic flow chart depicting the program flow of a software application in the structure of FIG. 1.

FIG. 4B is a schematic flow chart depicting the selection of stocks of the present invention

FIG. 4C is a schematic flow chart depicting the selection of stocks of the present invention

FIG. 4D is a schematic flow chart depicting the selection of stocks of the present invention

FIG. 4E is a schematic flow chart depicting the selection of stocks of the present invention

FIG. 4F is a schematic flow chart depicting the selection of stocks of the present invention

FIG. 5 is the list of stocks resulting from the selection process in FIG. 4A

FIG. 6 is the list of stocks resulting from the selection process in FIG. 4B

FIG. 7 is the list of stocks resulting from the selection process in FIG. 4C

FIG. 8 is the list of stocks resulting from the selection process in FIG. 4D

FIG. 9 is the list of stocks resulting from the selection process in FIG. 4E

FIG. 10 is the list of stocks resulting from the selection process in FIG. 4F

### DETAILED DESCRIPTION OF THE INVENTION

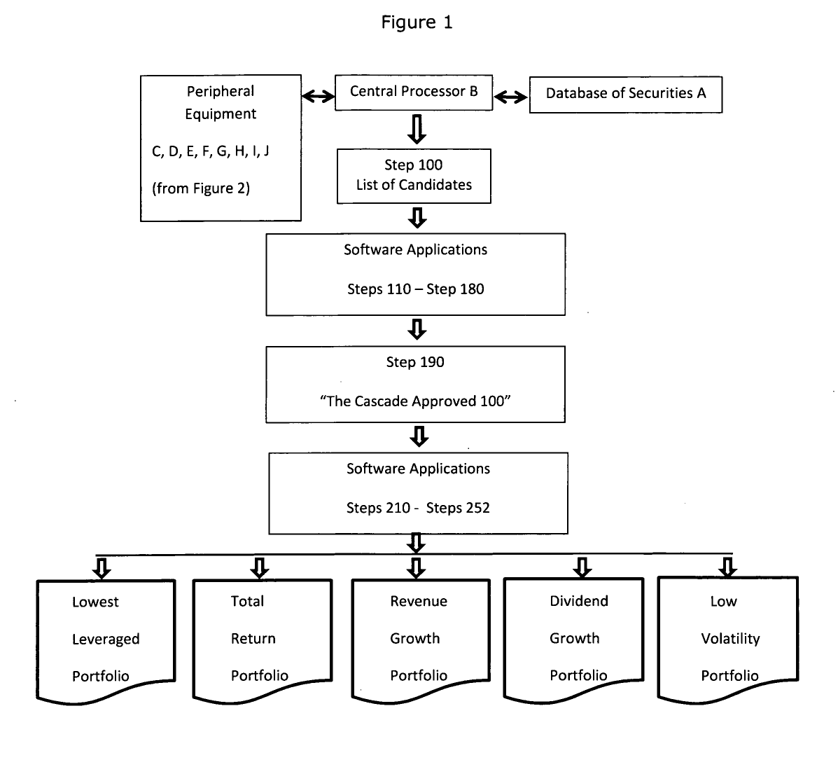

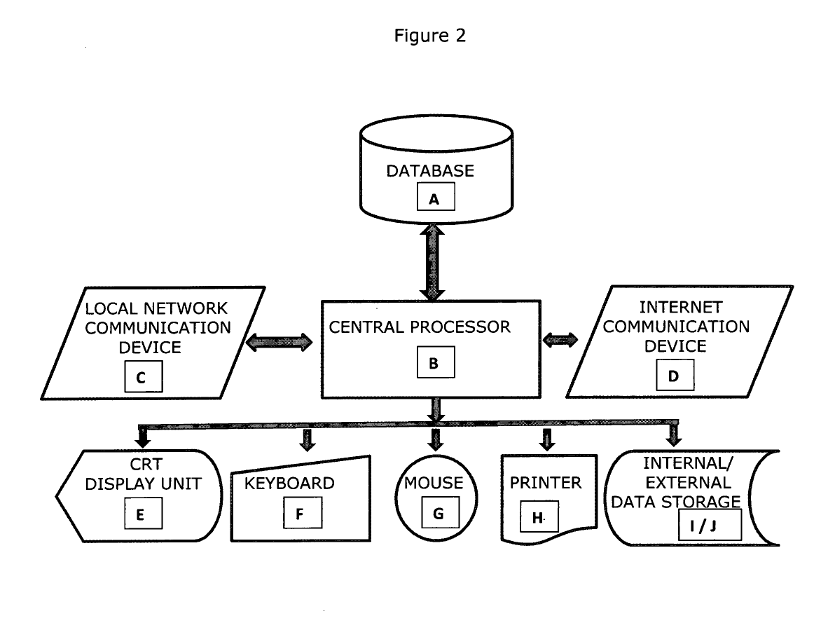

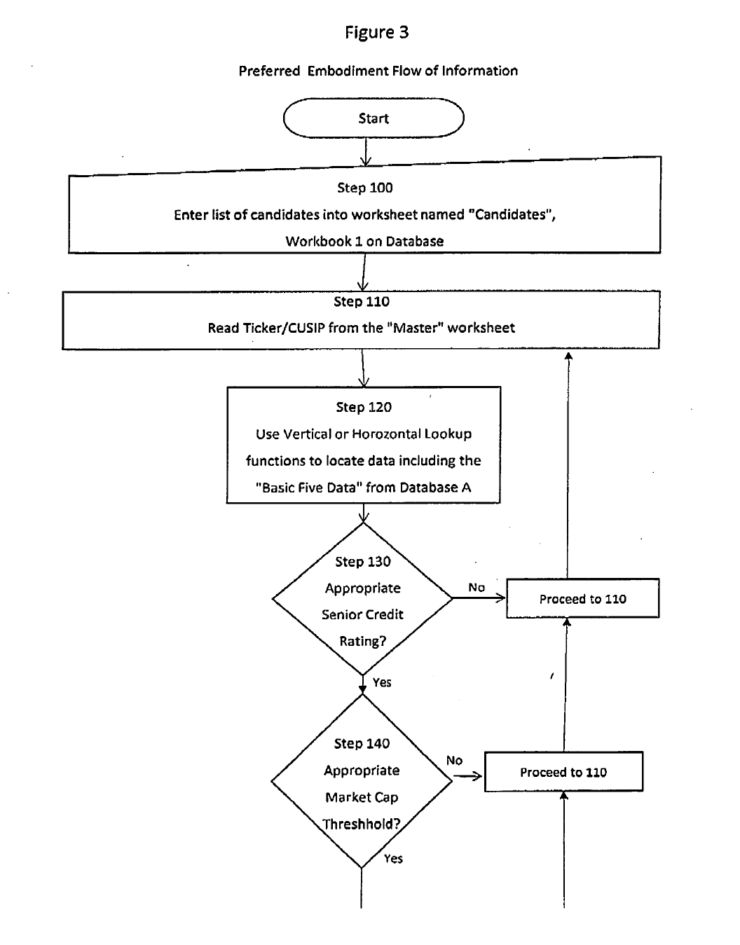

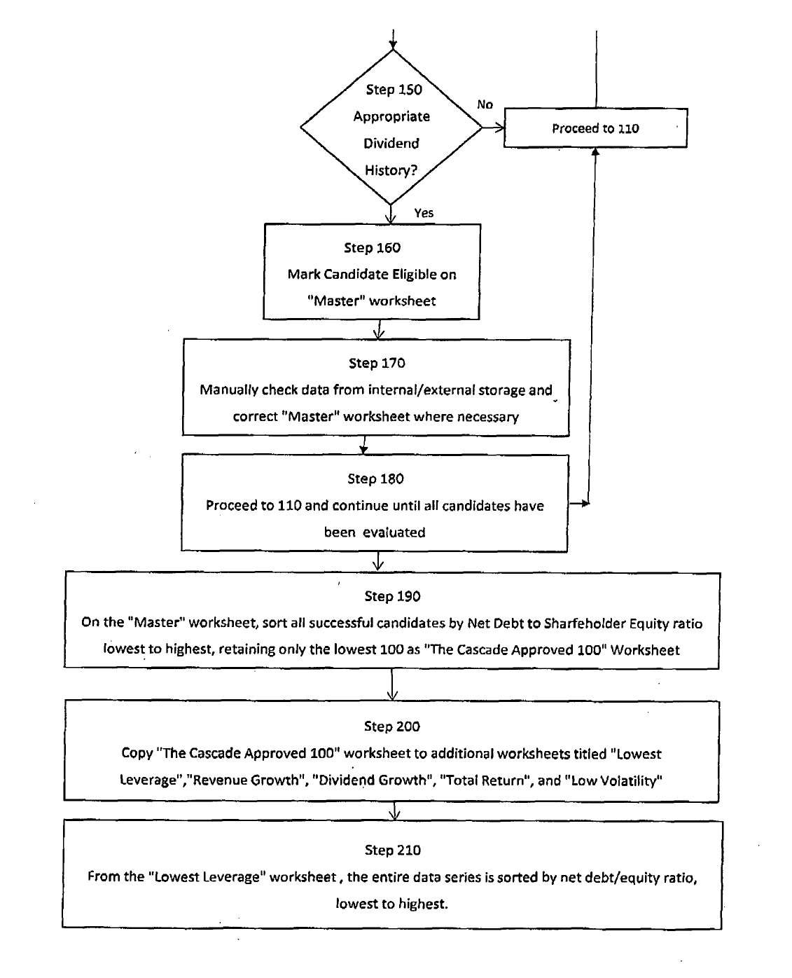

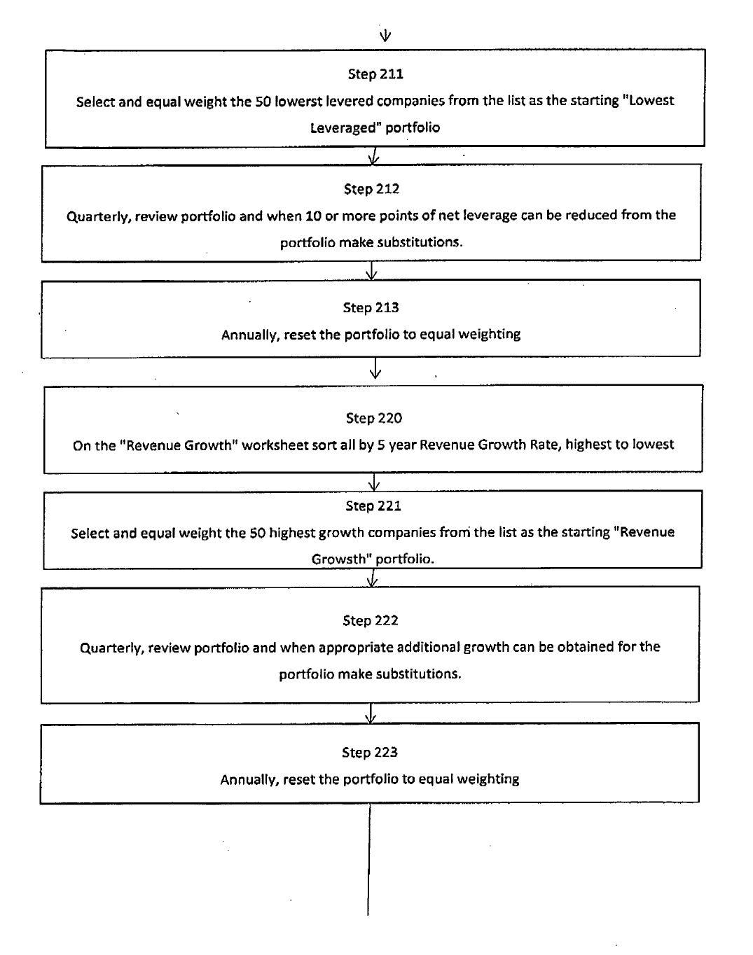

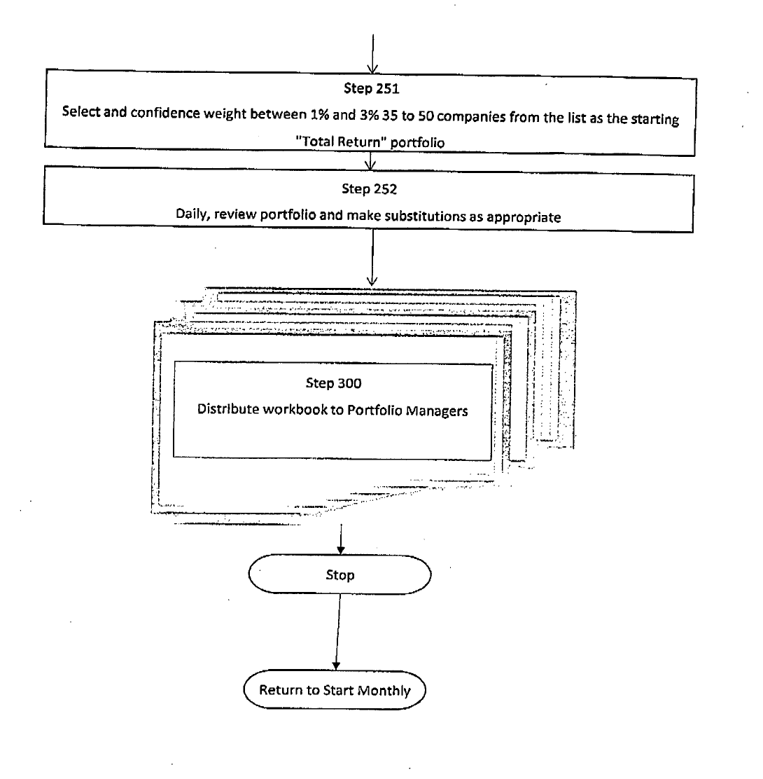

Referring to FIGS. 1 and 2, a securities database (A) receives and stores data using a computing system processor (B) located on either a personal computer or through shareware located on a server (not shown). The computing software in Central Processor (B) can be any commercially available spreadsheet software such as Microsoft Excel, relational database management systems such as SQL or a privately designed spreadsheet system that employs sorting subsystems and vertical and horizontal lookup functions.

Referring to FIG. 2, Step 100 requires that the user of the invention submit manually to the database a preliminary list of candidates. The list of candidates may consist of the Cascade Approved List, the Standard & Poor's 500, the Russell 3000, or any other list of companies. The initial data must contain the Name, Ticker Symbol or CUSIP/identification number; it is manually entered into vertical columns onto named workbooks in Database (A) onto worksheets labeled “Master” through the use of Keyboard (F), Mouse (G) and CRT Display Unit (E) all of which are connected directly or indirectly (wirelessly) to the Central Processor (B). Subsequent data can be added either manually or electronically from Internal Storage (I) or External Storage (J), or through the Internet via Internet Communication Device (D) or a LAN Device (C).

Data may be derived from any reliable source including e-Signal, Reuters, S&P Compustat, etc. The extent of information on each security may be vast or modest, but the invention requires the following “Basic Seven Data” at a minimum:
1. Market Capitalization.
2. Senior Unsecured Credit ratings from at least two (2) recognized credit rating agencies.
3. Sufficient balance sheet data on each candidate to determine the net debt of the candidate.
4. Sufficient balance sheet data on each candidate to determine the net shareholder equity.
5. Dividend history of the Company.
6. Indicated forward dividend rate.
7. Consensus earnings per share forecast for current and future years.

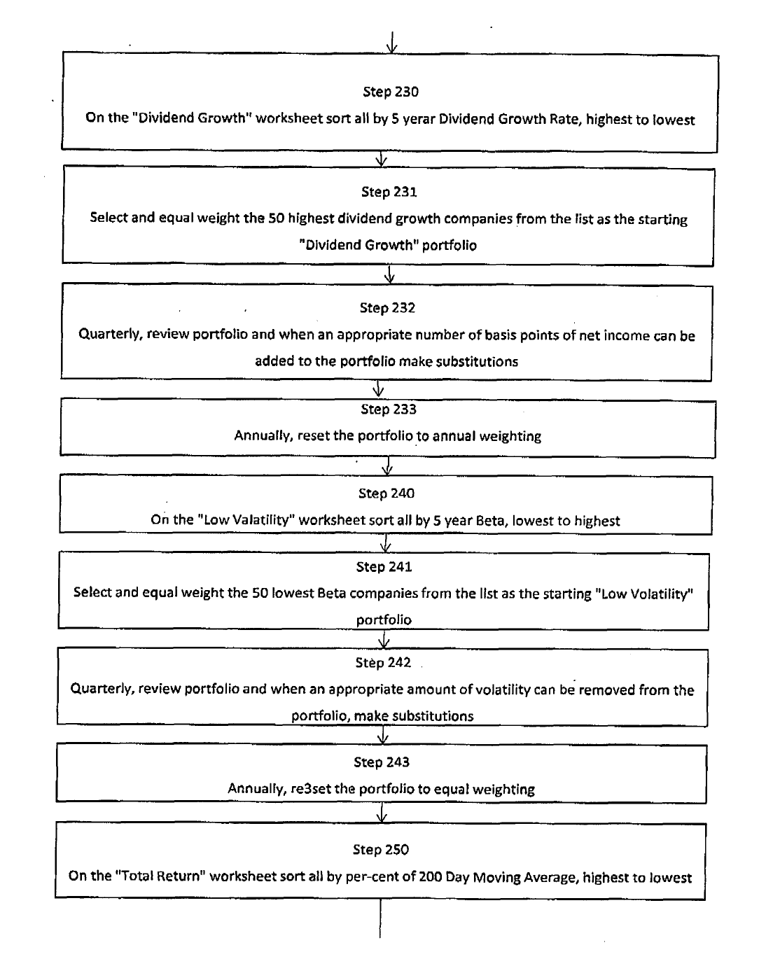

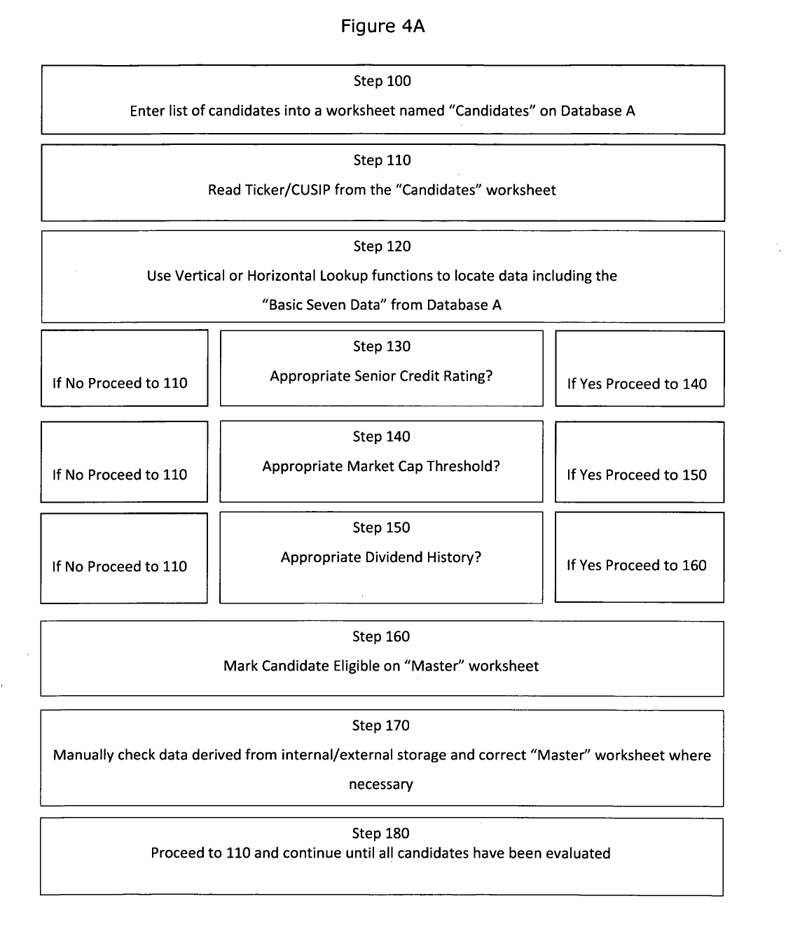

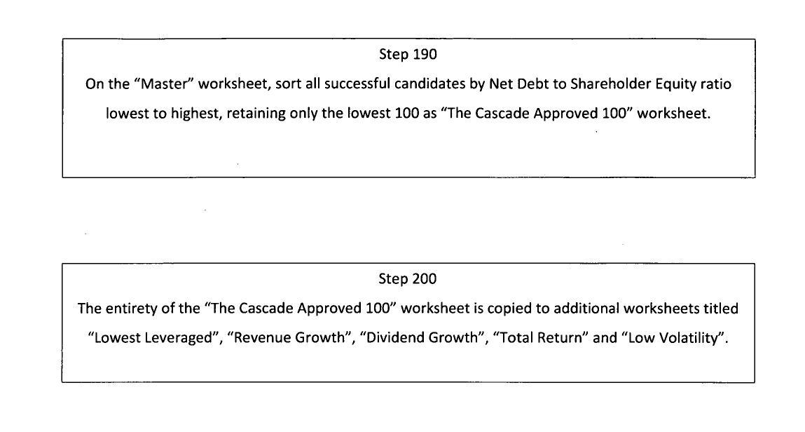

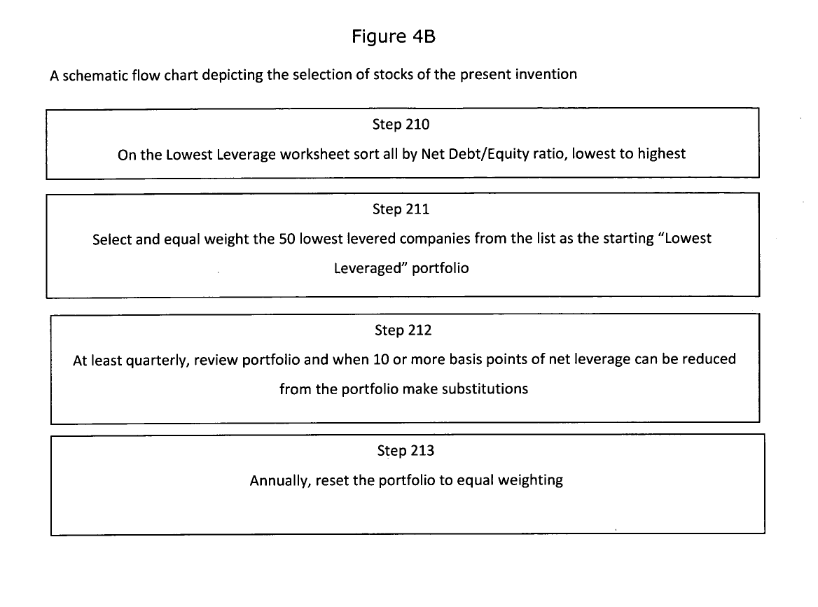

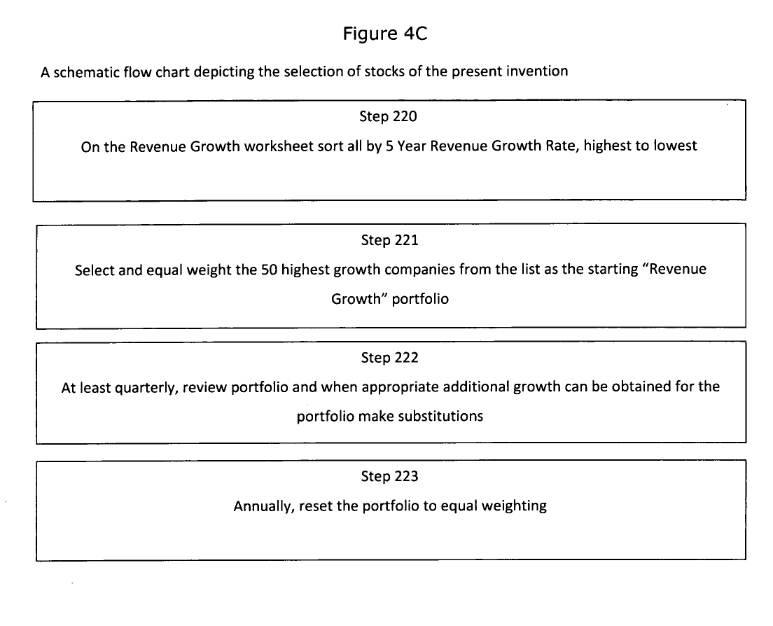

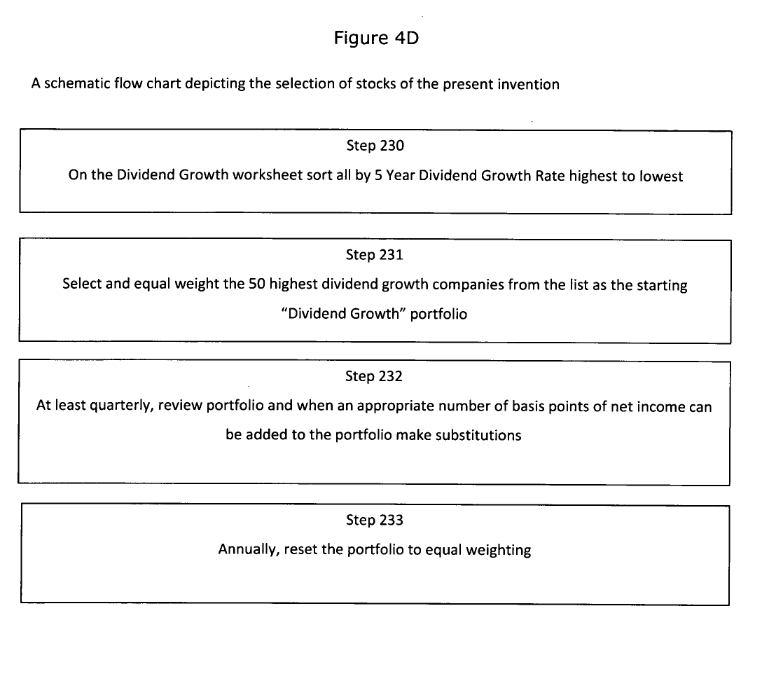

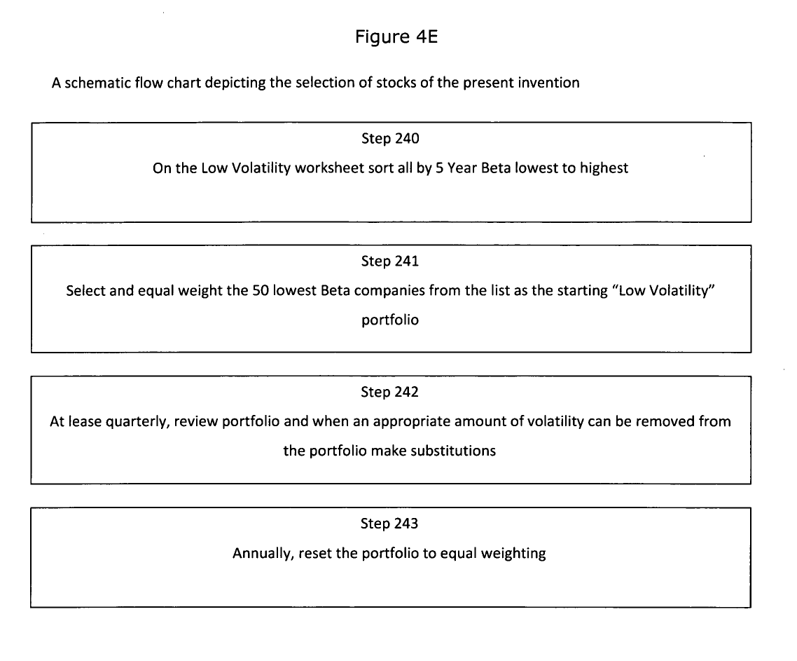

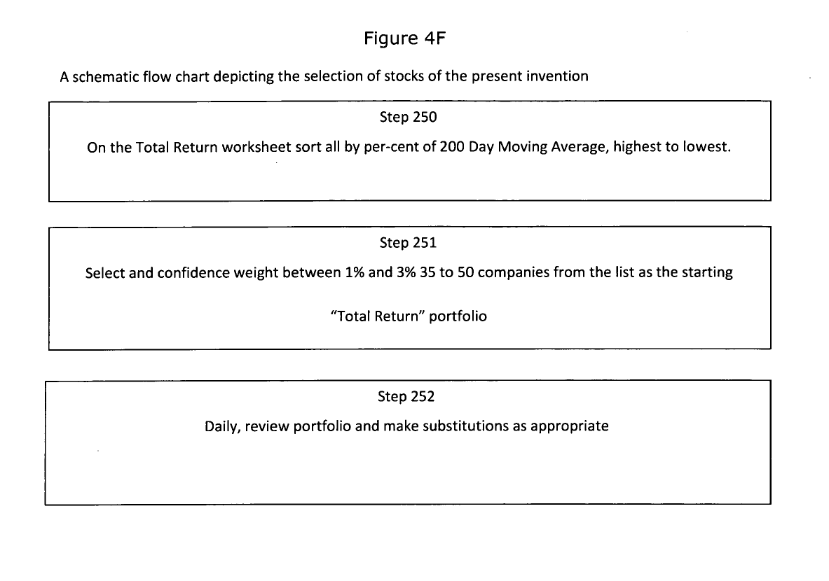

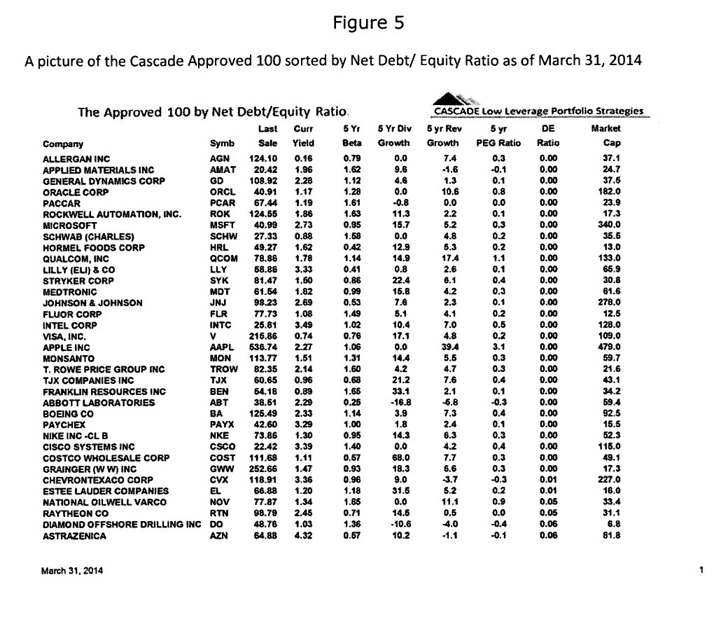

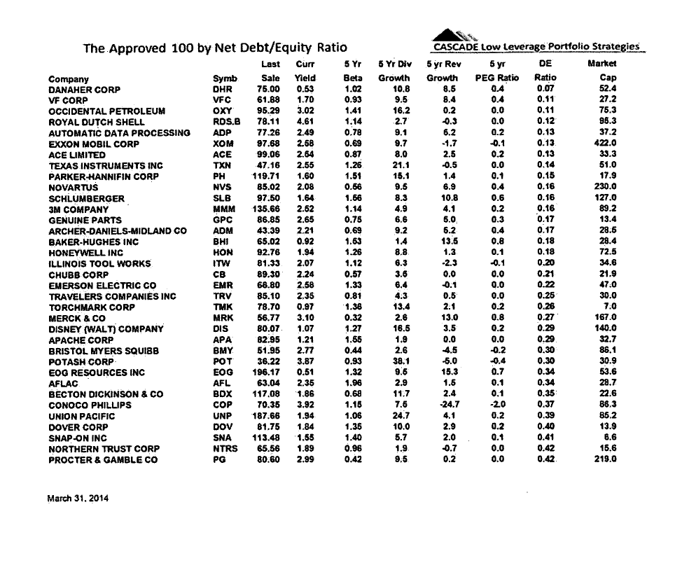

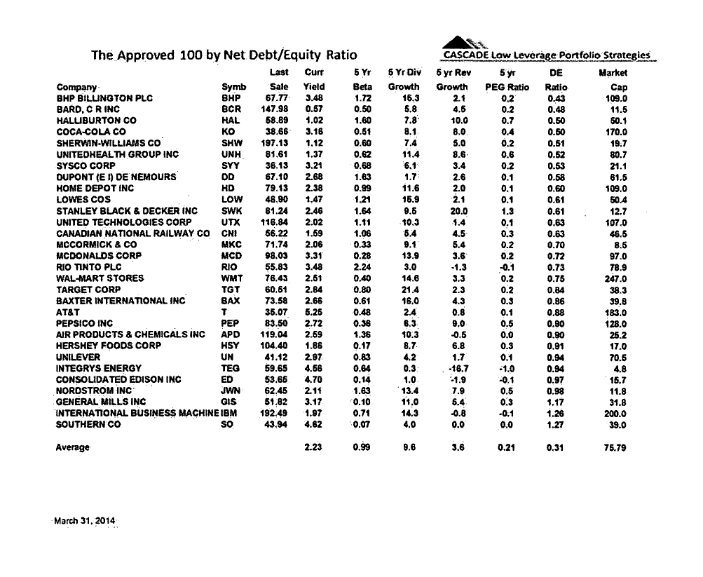

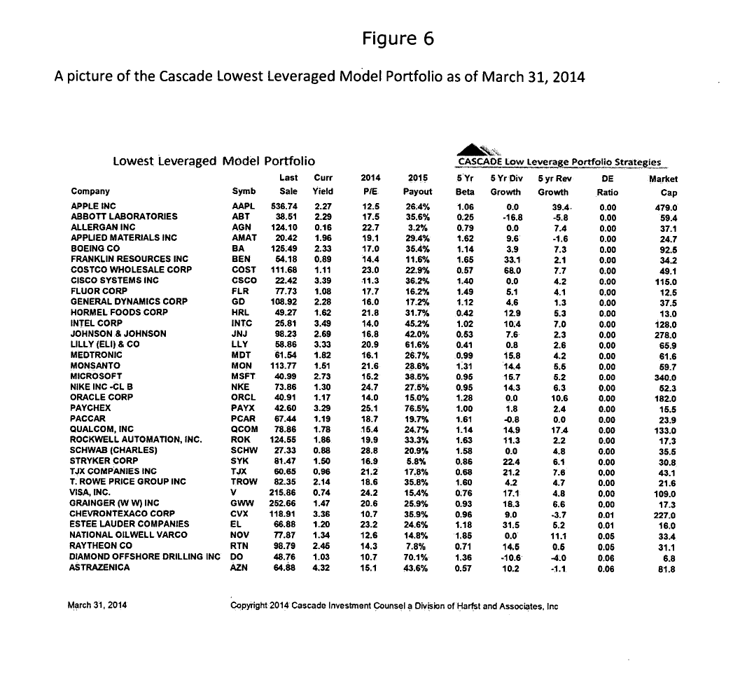

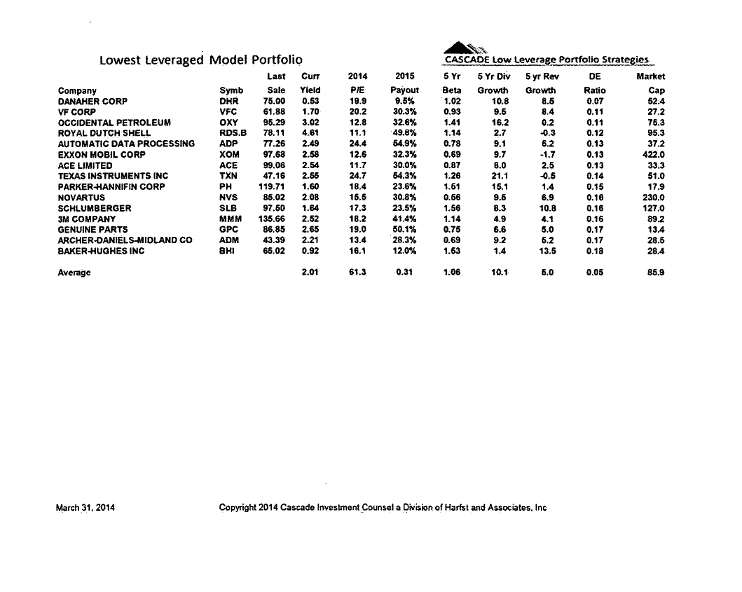

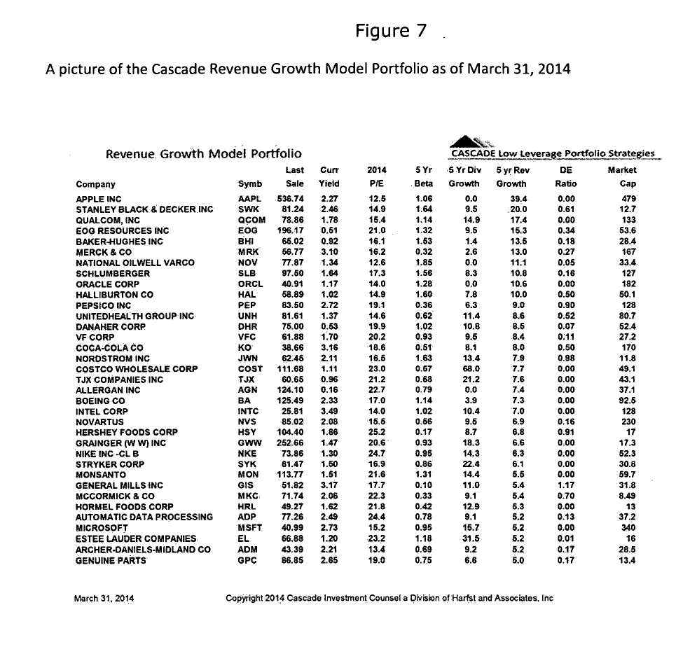

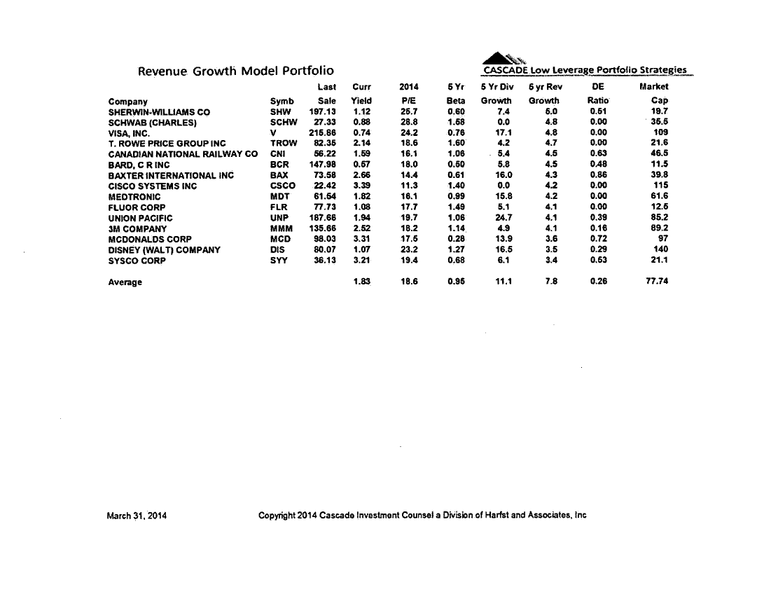

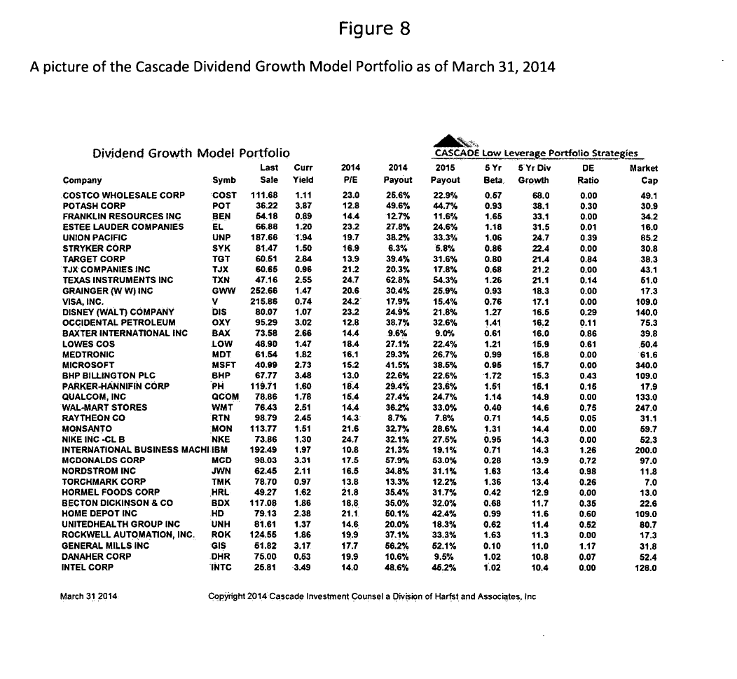

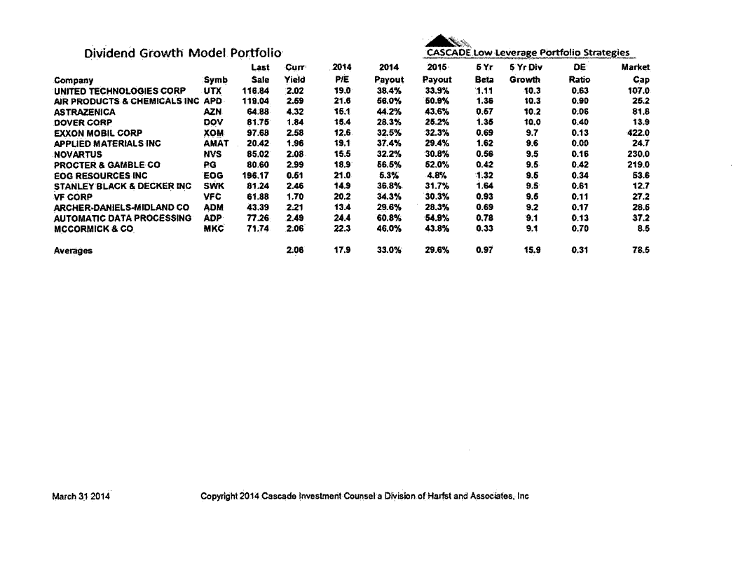

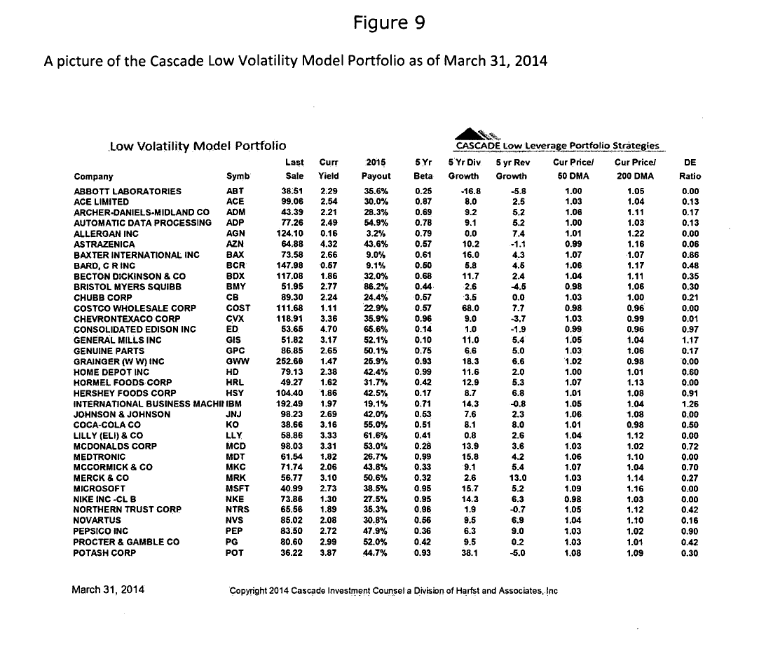

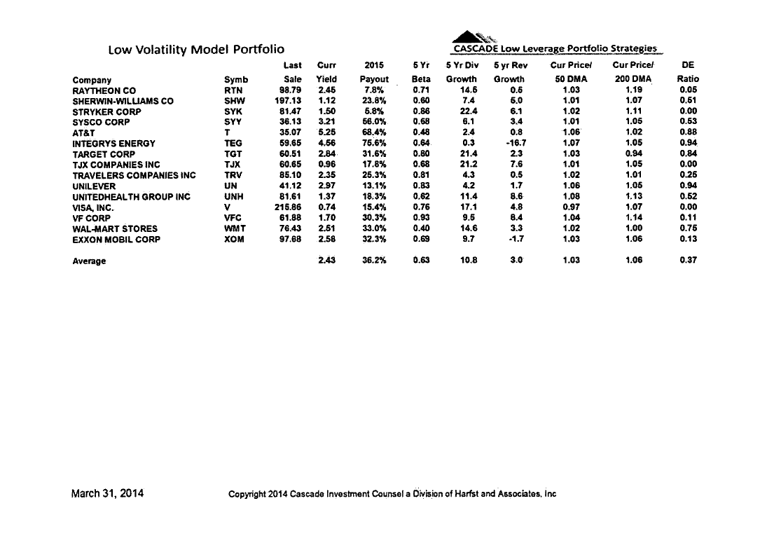

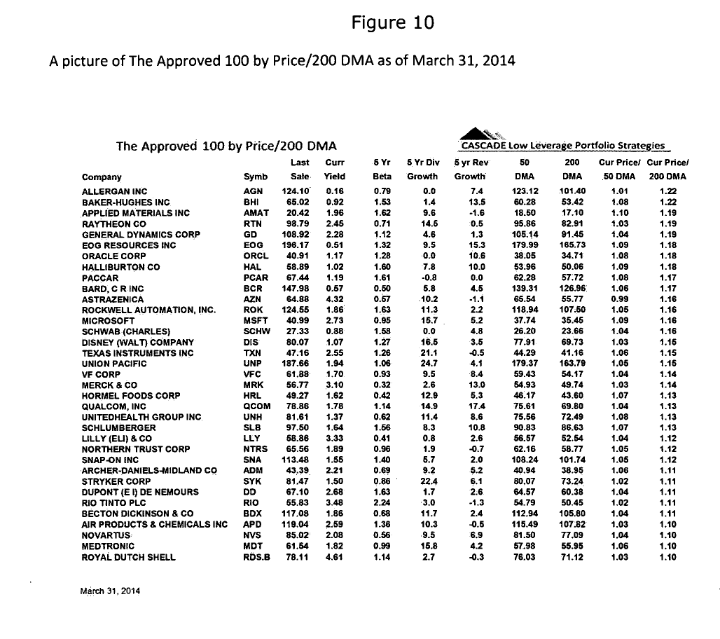

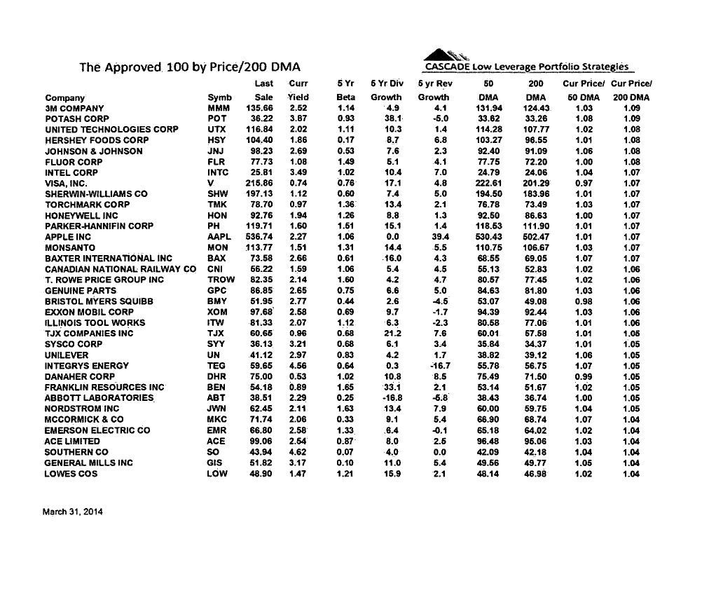

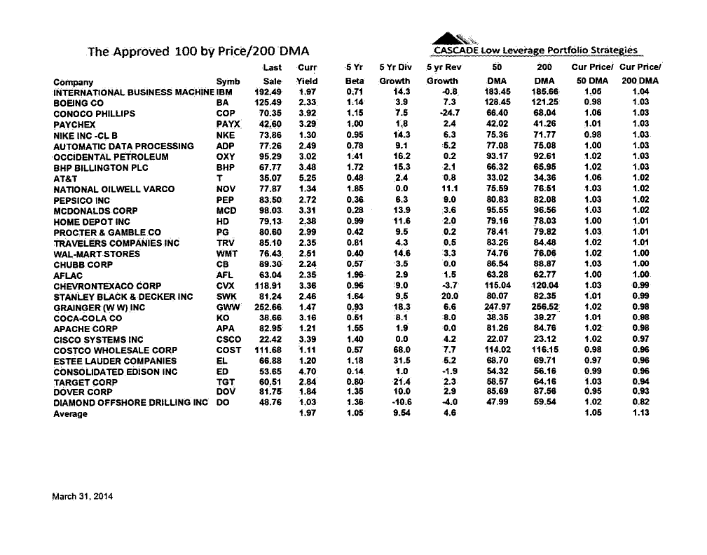

Referring to FIG. 4A, at Step 110 the invention reads the corporate equity identification symbol or number from the “Master” worksheet from the appropriate workbook i.e. The Cascade Approved List, the Standard & Poor's 500, the Russell 3000, the MSCI All World x US, etc.

At Step 120, using a vertical lookup function in the spreadsheet, data, including the “Basic Seven Data” of the candidate security are copied and transferred from Database A into the “candidates” worksheet on the workbook.

At Step 130, the Senior Unsecured Credit Rating is analyzed to determine a rating of Legal Grade or higher (the rating can be altered to screen for any desired level). If the candidate fails to pass the screen, the next candidate is located in a return to Step 110. If the candidate passes the screen the process moves to Step 140.

At Step 140 the current Market Capitalization level of the candidate is analyzed. A minimum market capitalization level can be altered to screen for any desired level. If the candidate fails to pass the screen, the next candidate is located in a return to Step 110. If the candidate passes the screen the process moves to Step 150.

At Step 150 the Dividend History of the candidate is analyzed. As not all embodiments of the invention require that a successful candidate pays a dividend, manual modification to the worksheet is often necessary in this step. If the candidate fails to pass this screen, the next candidate is located in a return to Step 110. If the candidate passes the screen the process moves to Step 160.

At Step 160 the “Master” worksheet is marked “yes” in the appropriate column and the process moves to Step 170.

At Step 170, all data entered into the “Master” worksheet of the workbook is manually screened for obvious errors. Such data includes but is not limited to: the assigned SIC Code, Last Sale, Current Yield, Net Debt levels, Senior Unsecured Debt Ratings, Current Earnings per share, Current P/E Ratio, consensus earnings for next year, P/E Ratio on next years expected earnings, 52 Week High, 52 Week Low, Next Dividend, Annual Dividend Rate, estimated next year dividend rate, 5 Year Beta, 5 Year EPS Growth, Return on Shareholder Equity, Return on Assets, Gross Margin, Cash Flow Per Share, Cash Flow/Dividend, 5 Year Revenue Growth, PE/Growth Ratio, Current Ratio, Long Term Debt/Equity, 50 Day Moving Average Price, 200 Day Average Moving Price. Data is corrected when necessary in the appropriate worksheet and/or appropriate location in Database A.

At Step 180, the process returns to Step 110 until all proposed candidates in the “Master” worksheet have been addressed and the data from worksheets in the appropriate workbooks updated.

At Step 190, on the “Master” worksheet, sort all successful candidates by Net Debt to Shareholder Equity ratio, lowest to highest, retaining only the lowest 100 as “The Cascade Approved 100” worksheet.

At Step 200 the lowest leveraged 100 of the “Net Debt Ratio” worksheet are copied to additional worksheets titled “Lowest Leverage”, “Revenue Growth”, “Dividend Growth”, “Total Return” and “Low Volatility”.

Referring to FIG. 4B at Step 210 on the “Lowest Leverage” worksheet, the entire data series is sorted by net debt/ equity ratio, lowest to highest. At Step 211 the 50 lowest leveraged companies are chosen for an initial portfolio. They are reviewed at least quarterly at Step 212 and again annually at Step 213.

Referring to FIG. 4C at Step 220 on the “Revenue Growth” worksheet, the entire data series is sorted by 5 year revenue growth rate, highest to lowest. At Step 221 the 50 highest 5 year revenue growth companies are chosen for an initial portfolio. They are reviewed at least quarterly at Step 222 and again annually at Step 213.

Referring to FIG. 4D at Step 230 on the “Dividend Growth” worksheet, the entire data series is sorted by the 5 year dividend growth rate highest to lowest. At Step 231 the 50 5 year dividend growth companies are chosen for an initial portfolio. They are reviewed at least quarterly at Step 232 and again annually at Step 233.

Referring to FIG. 4E at Step 240 on the “Low Volatility” worksheet, the entire data series is sorted by the 5 year Beta, lowest to highest. At Step 241 the 50 lowest Beta companies are chosen for an initial portfolio. They are reviewed at least quarterly at Step 242 and again annually at Step 243.

Referring to FIG. 4F at Step 250 on the “Total Return” worksheet, the entire data series is sorted by the percent above the 200 day moving average, highest to lowest. At Step 251, 35 to 50 issues are chosen and confidence weighted between 1% and 3%. At Step 252, the portfolio is reviewed daily and changes made where appropriate gains can be anticipated in overall total performance.

| REFERENCES CITED | Filing Date | |
|---|---|---|
| 6,317,726 | Jul. 7, 1999 | O'Shaughnessy |
| 6,839,685 | Oct. 30, 1998 | Leistensnider et al. |
| 7,206,760 | Jan. 7, 2000 | First Trust |
| 7,987,130 | Apr. 21, 2008 | First Trust |
| 7,949,591 | May 24, 2011 | First Trust |
| 8,364,649 | May 21, 2010 | Hensley, et al. |
| 8,595,118 | Oct. 29, 2012 | McGarel, et al. |
| 8,301,538 | Mar. 28, 2011 | McGarel, et al. |
| 8,346,649 | Jul. 22, 2011 | Hensley, et al. |
| 20130124433 A1 | December 2012 | Waldron, et al. |

### OTHER REFERENCES

G. Muradoglu and S. Sivaprasad, Using Firm Leverage as an Investment Strategy (November 2009). SSRN: http://ssrn.com/abstract=1031198 or http://dx.doi.org/10.2139/ssrn.1031198

What is claimed is:

1. A computer implemented method for selecting equity securities for passively or actively managed individual portfolios comprising the steps of:
inputting information of an initial selection of candidate securities into a database workbook where the information includes at minimum seven factors including (a) market capitalization, (b) senior unsecured credit ratings from at least one (1) recognized credit rating agency, (c) sufficient balance sheet data on each candidate to determine the net debt of the candidate, (d) sufficient balance sheet data on each candidate to determine the net shareholder equity, (e) sufficient dividend history to determine dividend stability, current dividend yield and a (f) minimum of five years of earnings per share history and consensus earnings forecast for the current and following year(s); processing data in said workbook to determine portfolio eligibility based above factors a, b, c, d and e; sorting the data on the “Net Debt Ratio” worksheet, whereby all eligible candidates are displayed by their Net Debt to Shareholder Equity ratio lowest to highest; copying the data from the first 100 eligible securities on the “Net Debt Ratio” worksheet onto worksheets named“, “Lowest Leverage”, “Revenue Growth” , “Dividend Growth”, “Low Volatility” and “Total Return”; sorting the data on worksheet “Lowest Leverage” by net debt to equity ratio, lowest to highest and initially selecting and equal weighting the 50 lowest leveraged companies; sorting the data on worksheet “Revenue Growth” by 5 year revenue growth rate, highest to lowest and initially selecting and equal weighting the 50 highest revenue growing companies; sorting the data on worksheet “Dividend Growth” by growth rate, highest to lowest initially selecting and equal weighting the 50 highest dividend growth companies; sorting the data on worksheet “Low Volatility” by 5 year Beta and initially selecting and equal weighting the lowest 50 Beta securities; sorting the data on the “Total Return” worksheet and initially selecting between 35 and 50 securities and confidence weighting between 1% and 3%; rebalancing all portfolios periodically, wherein one or more of the above steps are performed by the computing system.

2. The method of claim 1, wherein the factors leading to a candidates selection are the Senior Subordinated Credit Rating, the Market Capitalization, the dividend history and the Net Debt to Shareholder Equity Ratio.

3. The method of claim 1, wherein the iteration of FIG. 4A, Step 100 is used to create the “Master” worksheet based upon the population of the Candidates List wherein the Senior Unsecured Credit Rating at FIG. 4, Step 130 is to be set at single A by at least one (1) recognized rating agency; wherein the minimum market capitalization 1 at FIG. 4, Step 140 is to be set at $5 billion; wherein the appropriate dividend history at FIG. 4, Step 150 is to be continuous with no reduction in annual payments in the 10 prior years.

4. The method of claim 1, wherein the iteration of FIG. 4A, Step 100 is used to create a second embodiment Workbook based upon the population of the Standard& Poor's 500 Index.

5. The method of claim 1, wherein the iteration of FIG. 4A, Step 100 is used to create a third embodiment Workbook based upon the population of the Russell 3000 Index.

6. The method of claim 1, wherein the iteration of FIG. 4A, Step 100 is used to create a fourth embodiment Workbook based upon the population of the MSCI All World x US Index.

7. The method of claim 1, wherein the lowest leveraged 100 securities are chosen for “The Cascade Approved 100”.

8. The method of claim 1, further comprising FIGS. 4A-4F, Steps 200 through 252 of building, reconstituting and rebalancing the securities in five low leverage strategies named “Lowest Leverage”, “Revenue Growth, “Dividend Growth”, “Low Volatility” and “Total Return” periodically.

9. The method of claim 3, wherein various investment vehicles are constructed based on the portfolios generated by the method of claim 1.

10. The investment vehicle of claim 9 is an exchange traded fund.

11. An enhanced index of claim 10 based upon the target stock portfolio generated by the method of claim 3.

12. The enhanced index of claim 11 is constructed by a first party different from a second party generating the target stock portfolio.
